(19) United States
(12) Patent Application Publication
(10) Pub. No.: US 2017/0225879 A1
(43) Pub. Date: Aug. 10, 2017

(54) SERVING UNIT AND SERVING KIT

(71) Applicant: Looksee, Inc, New York, NY (US)

(72) Inventors: Bart Stein, New York, NY (US); Laura Rose Semo Scharfman, Mountain View, CA (US); Conrad Stern-Ascher, Durham, NC (US); Jena Derman, Brooklyn, NY (US); Evan Abel, Brooklyn, NY (US); Daniel Turk, New York, NY (US); Walter Lark, Brooklyn, NY (US); Thomas Nguyen, Brooklyn, NY (US); Albert Ho, New York, NY (US); Jeff de Picciotto, New York, NY (US); Michael Van Dyke, Madison, WI (US); Todd Bakken, Madison, WI (US)

(21) Appl. No.: 15/427,994

(22) Filed: Feb. 8, 2017

Related U.S. Application Data
(60) Provisional application No. 62/292,560, filed on Feb. 8, 2016.

(51) Int. Cl. B65D 85/804; B65D 43/02; A23G 9/22; B65D 25/20; A23G 9/40; B65D 85/60; B65D 17/50

(52) U.S. Cl. CPC B65D 85/804; B65D 85/60; B65D 43/02; B65D 17/501; B65D 25/205; A23G 9/40; A23G 9/224

(57) ABSTRACT

One variation of a serving unit includes: a base; a wall extending from the base, including a frustoconical section, and defining a central axis; a rim extending from an upper edge of the wall; a seal extending across the rim and transiently enclosing a cavity defined by the wall and the base; a beater arranged within the cavity, configured to rotate about the central axis, including blades configured to extend along the base and up a portion of the wall, and including a drive coupling coaxial with the central axis; and a dry powdered food product arranged within the cavity and including a first quantity of flavoring, a second quantity of sweetener, and a third quantity of thickener.

### CROSS-REFERENCE TO RELATED APPLICATIONS

This Application claims the benefit of U.S. Provisional Application No. 62/292,560, filed on 8 Feb. 2016, which is incorporated in its entirety by this reference.

This Application is related to U.S. patent application Ser. No. 15/357,860, filed on 21 Nov. 2016, which is incorporated in its entirety by this reference.

### TECHNICAL FIELD

This invention relates generally to the field of dry powder mixes and more specifically to a new and useful serving unit and serving unit kit in the field of dry powder mixes.

### BRIEF DESCRIPTION OF THE FIGURES

FIG. 1 is a schematic representation of a serving unit;

FIG. 2 is a schematic representation of a serving kit;

FIGS. 3A, 3B, and 3C are schematic representations of one variation of the serving unit;

FIG. 4 is a flowchart representation of one variation of the serving unit;

FIGS. 5A, 5B, and 5C are schematic representations of one variation of the serving unit;

FIG. 6 is a graphical representation of one variation of the serving unit;

FIG. 7 is a flowchart representation of one variation of the serving unit;

FIG. 8 is a flowchart representation of one variation of the serving unit; and

FIG. 9 is a graphical representation of one variation of the serving unit.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

1. Serving Unit

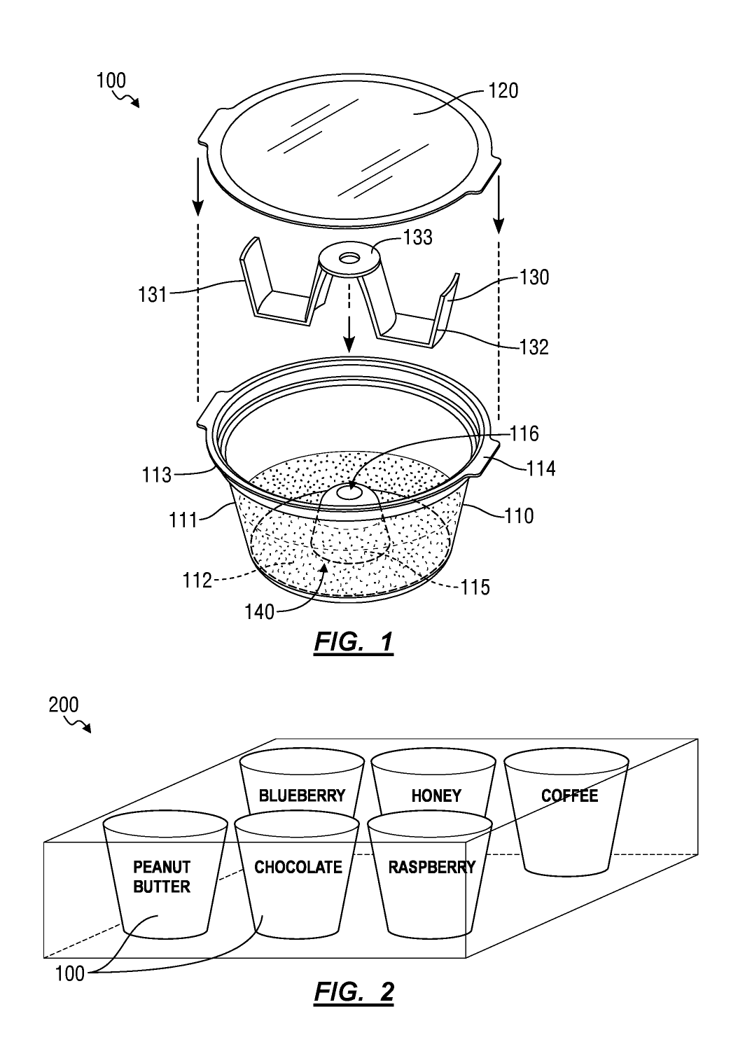

As shown in FIG. 1, a serving unit 100 includes: a cup 110 including a base 112, a lip offset above the base 112, and a wall 111 extending from the base 112 to the lip, the cup 110 defining a fluid fill level indicator between the base 112 and the lip; a beater 130 arranged within the cup 110 and including a blade configured to contact a surface of the wall 111; a volume of dry powder mix 140 arranged in the cup 110; and a seal 120 transiently coupled to the lip of the cup 110 and sealing the volume of dry powder mix 140 within the cup 110. The volume of dry powder mix 140 includes: a quantity of powdered fruit; a quantity of citric acid 142 matched to the quantity of powdered fruit; a quantity of a second acid 143 distinct from citric acid, the quantity of the second acid 143 configured to cooperate with the quantity of citric acid 142 to gel a portion of milk proteins in a volume of milk product added to the cup 110 up to the fluid fill level indicator; a quantity of thickening hydrocolloid configured to rehydrate from the volume of milk product added to the cup 110 and to form a network of polymer chains; a quantity of powdered yogurt 147; and a quantity of sugar.

One variation of the serving unit 100 includes: a base 112; a wall 111 extending from the base 112, including a frustoconical section, and defining a central axis; a rim 113 extending from an upper edge of the wall 111; a seal 120 extending across the rim 113 and transiently enclosing a cavity defined by the wall 111 and the base 112; a beater 130; and a dry powdered food product 146. The beater 130 is arranged within the cavity, is configured to rotate about the central axis, and includes: a first blade 131 configured to extend along the base 112 and up a portion of the wall 111; a second blade 132 radially offset from the first blade 131 and configured to extend along the base 112 and up a portion of the wall 111; and a drive coupling 133 interposed between the first blade 131 and the second blade 132 and extending opposite the base 112. The dry powdered food product 146 is arranged within the cavity and includes: a first quantity of flavoring 146; a second quantity of sweetener 141; and a third quantity of thickener 144.

One variation of the serving unit 100 includes: a first cup defining a first cavity and configured to engage a cooled receptacle within a frozen food processing apparatus; a first beater configured to rotate within the cavity and including a drive coupling configured to engage a motorized shaft extending from the frozen food processing apparatus over the cooled receptacle; a first amount of dry powdered food product 146 arranged within the first cavity; and a first seal transiently arranged over the first cavity and transiently sealing the beater and the first dry powdered food product 146 within the first cavity.

2. Serving Kit

Similarly, as shown in FIG. 2, a serving kit 200 includes: a first serving unit 100 and a second serving unit. In this variation, the first serving unit 100 includes: a first cup including a base 112, a lip offset above the base 112, and a wall 111 extending from the base 112 to the lip, the first cup defining a first fluid fill level indicator between the base 112 and the lip; a first beater arranged within the cup 110 and including a blade configured to contact a surface of the wall 111; a first volume of dry powder mix 140 arranged in the first cup; and a first seal transiently coupled to the lip of the first cup and sealing the first volume of dry powder mix 140 within the first cup. The second serving unit 100 includes: a second cup substantially identical to the first cup and defining a second fluid fill level indicator substantially identical to the first fluid fill level indicator; a second beater substantially identical to the first beater and arranged within the second cup; a second volume of dry powder mix 140 arranged in the second cup; and a second seal transiently coupled to the lip of the second cup and sealing the second volume of dry powder mix 140 within the second cup. The first volume of dry powder mix 140 (a dry “fruity” mix) includes: a proportion of powdered fruit; a proportion of citric acid 142 matched to the proportion of powdered fruit; a proportion of a second acid 143 distinct from citric acid, the proportion of the second acid 143 configured to cooperate with the proportion of citric acid 142 to gel a portion of milk proteins in a volume of milk product added to the first cup up to the first fluid fill level indicator; a first proportion of thickening hydrocolloid 145 configured to rehydrate from the volume of milk product added to the first cup and to form a network of polymer chains; a first proportion of powdered yogurt 147; and a first proportion of sweetener 141. However, the second volume of dry powder mix 140 (a dry “roasted” mix) includes: a second proportion of sweetener 141 less than the first proportion of sweetener 141; a proportion of dried ground nut particulate; a proportion of gelling hydrocolloid; a second proportion of thickening hydrocolloid 145 greater than the first proportion of thickening hydrocolloid 145, configured to rehydrate from the volume of milk product added to the first cup, and configured to form a network of polymer chains; and a second proportion of powdered yogurt 147.

A serving kit 200 can similarly include: a first container 110; a first amount of fruity dry powdered food product 146 sealed within the first container 110; a second container; and a second amount of nutty dry powdered food product sealed within the second container. The fruity dry powdered food product 146 includes: a first proportion of dried fruit particles; a first proportion of citric acid 142 matched to the quantity of dried fruit particles and configured to gel proteins in a first volume of milk product added to the first container 110; a first proportion of thickening hydrocolloid 145 in a disperse phase, configured to rehydrate in the presence of the first volume of milk product added to the first container 110, and configured to form a network of polymer chains within the volume of milk product; a first proportion of powdered yogurt 147; and a first proportion of dry sweetener 141. The second amount of nutty dry powdered food product includes: a second proportion of dried ground nut particulate greater than the first proportion of dried fruit particles; a second proportion of thickening hydrocolloid greater than the first proportion of thickening hydrocolloid, the second proportion of thickening hydrocolloid in the disperse phase, configured to rehydrate in the presence of a second volume of milk product added to the second container, and configured to form a network of polymer chains; a second proportion of powdered yogurt approximating the first proportion of powdered yogurt; and a second proportion of sweetener approximating the first proportion of sweetener.

3. Applications

Generally, the serving unit 100 includes a cup 110, a beater 130, a dry powdered food product 146 (hereinafter “dry powder mix 140”), and a seal 120 that seals the beater 130 and dry powder mix 140 within the cup 110. The cup 110 functions as: initially, a storage container for a dry powder mix 140 (e.g., a dry powder mix 140); later, a preparation container into which a liquid (e.g., ground- or animal-based milk) is added to the dry powder mix 140 and then transformed into a wet, frozen, edible suspension (e.g., frozen yogurt); and finally a bowl from which the suspension may be consumed by a user. In particular, the cup 110: defines a thermally-conductive container that conducts heat from its contents into a receptacle within a processing apparatus in order to free water molecules in the liquid added to the cup 110; and the serving unit 100 further includes an integrated beater that, when rotated within the cup 110, mixes the dry powder mix 140 with the added liquid within the cup 110 and scrapes ice crystals from interior surfaces of the cup 110. Because all surfaces of the cup 110 that contact the dry powder mix 140 and added liquid during a processing cycle are contained within the serving unit 100 (i.e., interior surfaces of the cup 110, the beater 130), little or no cleaning of the processing apparatus may be needed between uses. Because the serving unit 100 contains a sealed volume of dry powder mix 140, the serving unit 100 can be shipped and stored without refrigeration and can exhibit extended shelf life over a serving unit 100 containing a wet food product. Furthermore, because only addition of a liquid to the serving unit 100 is required to prepare the serving unit 100 to transform the dry powder mix 140 into an edible frozen foodstuff (e.g., frozen yogurt) and because this liquid may be relatively “fresh” (e.g., grocery store-supplied 2% milk used prior to an expiration date or farm-fresh whole milk), the serving unit 100 can be processed in the processing apparatus to create fresh frozen yogurt in a convenient period of time (e.g., less than ten minutes): with relatively minimal preparation or effort by the user; with no consumables other than electricity; and without sacrificing mouth feel, texture, or flavor of the frozen yogurt.

A serving unit 100 also contains a volume of flavored dry powder mix 140. For example, a serving unit 100 can contain a dry powder mix 140 contain: passionfruit; chocolate; strawberry; peanut butter; coffee; buttermilk; tart; wild berry; raspberry; apple; honey; or banana flavoring 146. To gel proteins in a milk product (e.g., whole milk, 2% milk) added to a cup 110 containing a “fruity” dry powder mix 140 (e.g., raspberry, strawberry, wild berry, tart, and honey flavors), a fruity dry powder mix 140 can include powdered acid that, when rehydrated by water in the added milk product, causes proteins (e.g., casein) in the milk product to coagulate. In particular, a volume of fruity dry powder mix 140 can include a proportion of powdered fruit (e.g., ˜18% by mass dry powdered raspberry) and can include a proportion of citric acid 142 (e.g., ˜3.5% by mass dry powdered citric acid) that is flavor-matched to the proportion of powdered fruit to achieve an appropriate level of citrus flavor in a suspension that is eventually produced when a milk product is added to the cup 110, mixed, beaten, and cooled. However, because the proportion of citric acid 142 in the dry powder mix 140 may be insufficient to coagulate enough protein in the added milk product, the fruity dry powder mix 140 can also include a second powdered acid (e.g., 2.1% by mass dry powdered lactic acid) that cooperates with the citric acid to completely (i.e., to an adequate degree) coagulate proteins in the added milk product and to augment a yogurt flavor of the suspension. Lactic acid can additionally or alternatively be included in the fruity dry powder mix 140 to enhance a yogurt flavor of the completed suspension.

However, inclusion of dry powdered (or granulated, etc.) citric acid in a “roasted” dry powder mix 140 (e.g., chocolate, peanut butter, and coffee flavors), may yield an adverse flavor profile in a suspension produced when a milk product is added to a cup 110 containing roasted dry powder mix 140, mixed, beaten, and cooled. In particular, some flavors, such as “roasted” (or “nutty”) flavors may not pair will with certain acids, such as citric acid. Therefore, to achieve sufficient gelling when processed with an added volume of milk product, a roasted dry powder mix 140 can include a gelling-type hydrocolloid in place of dry powdered acid. For example, a chocolate-flavored dry powder mix 140 can include ˜0.6% dry powdered organic agar gum (or lambda carrageenan) that functions to gel and stabilize proteins in a milk product later added to the chocolate-flavored dry powder mix 140. A dry powdered gelling activator (e.g., citric and/or lactic acid) or dry powdered gelling agent (e.g., organic agar gum) can therefore be selectively incorporated into a dry powder mix 140 based on a flavor type of the dry powder mix 140.

Furthermore, both fruity and roasted dry powder mixes can include one or more thickening-type hydrocolloids that form entangled networks when mixed with liquid and beaten in a cup 110, thereby thickening the resulting suspension and improving mouth feel (or “texture”) of this suspension. Types and quantities of thickening hydrocolloids incorporated into dry powder mixes can be selected for mouth melt-away characteristics, imparted sheen, clarity, and smoothness characteristics, impact on rich, soft, and creamy mouthfeel, etc. However, a volume of roasted dry powder mix 140 can include a greater proportion of thickening hydrocolloid 145 (e.g., a greater amount per unit mass) than a volume of fruity dry powder mix 140 in order to compensate for lack of additional acid in the roasted dry powder mix 140 such that a frozen food product produced from a quantity of the roasted dry powder mix 140 exhibits substantially similar thickness, gelling, and mouthfeel, etc. as a frozen food product produced from a quantity of the fruity dry powder mix 140 under substantially similar conditions—such as addition of the same type of liquid and processing under like processing cycles, as described below.

A serving unit 100 is described herein as including a cup 110 storing a dry powder mix (or a “base”) for frozen yogurt. To create a fresh serving of frozen yogurt that may be consumed directly from the cup 110: the seal 120 can be removed from the cup 110; fresh ground- or animal-based milk product can be added to the cup 110 (e.g., up to an indicated fill line); the cup 110 can be placed into a processing apparatus; and the processing apparatus can cool the cup 110 and rotate the beater 130 to transform the dry powder mix 140 and the added milk product into a frozen suspension. For example, once the cup 110 is filled with whole milk up to an indicated fluid fill level and installed in a receptacle in the processing apparatus, the processing apparatus can mix the whole milk and the dry powder mix 140 in situ within the cup 110 while cooling the cup 110 to: rehydrate some components of the dry powder mix 140; dissolve other components of the dry powder mix 140 (e.g., sugar) into the liquid; and create a low-temperature suspension of milk solids, cultures, and/or re-hydrated fruit particles, etc. in ice crystals (i.e., “frozen yogurt”). However, higher- and lower-fat dairy products, soy milk, almond milk, water, fruit juice, or any other liquid can be added to the cup 110 and processed with the dry powder mix 140 according to a common processing schedule to produce ice cream, gelato, or any other frozen food product.

4. Example

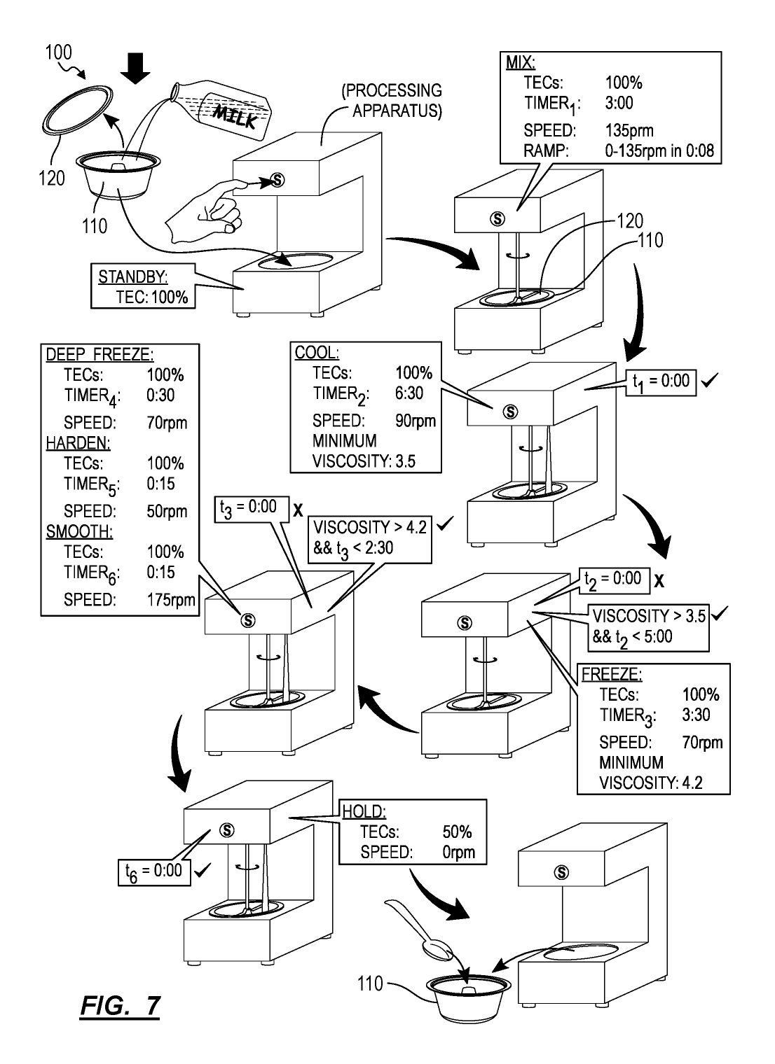

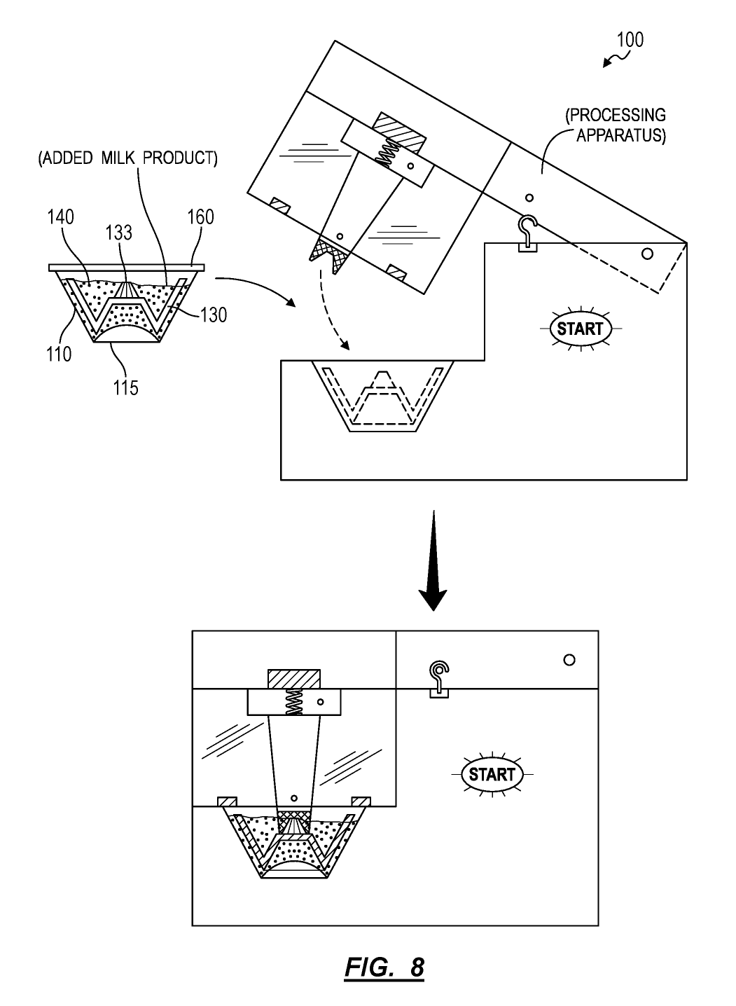

In one example shown in FIG. 7, a first cup defines a drawn or spun aluminum container, includes a food safe plastic (e.g., nylon) beater, and includes a foil-backed lid that seals a volume of fruity dry powder mix 140 within the first cup. In this example, a fruity dry powder mix 140 includes: conjointly freeze-dried honey and yogurt cultures; sugar; lactic and citric acid; thickening-type hydrocolloid; and dry raspberry fruit in a powdered format (e.g., particles with maximum dimensions less than 0.075″). The first cup and its contents can be distributed and stored in room-temperature environments until a user is inclined to prepare contents of the first cup for consumption. To prepare the contents of the first cup for consumption, the user peels the lid from the first cup, adds a liquid (e.g., whole milk, 2% milk, soy milk, water, fruit juice, etc.) to the first cup up to a fill line (i.e., the fluid fill level indicator) defined by the cup 110 and/or the beater 130, inserts the first cup into a receptacle in a processing apparatus, and selects a single “Start” button on the processing apparatus, as shown in FIGS. 7 and 8. In response to selection of the “Start” button, the processing apparatus activates a refrigeration unit—thermally coupled to the receptacle—at full-power (e.g., 100% duty), couples a rotary motor to the beater 130 (e.g., via an extensible driveshaft), and ramps the rotary motor from stationary to a first target speed of 135 rpm (such as +/−5%) over a period of eight seconds. (Alternatively, the processing apparatus can activate the refrigeration unit once a lid of the processing apparatus is opened and then ramp the rotary motor to the first target speed once the lid is closed and latched with a cup inside.) When the rotary motor reaches the first target speed, the processing apparatus sets a first time for 180 seconds. While the first timer counts down and the rotary motor rotates, the beater 130 breaks clumps of dry powder mix 140, mixes the dry powder mix 140 with the liquid in the first cup, and forces introduction of liquid (e.g., water) to dry powder thickening hydrocolloid, thereby hydrating the thickening hydrocolloid during a mixing stage. This rapid first target beater speed may also prevent clumping of the powder by dispersing the powder evenly throughout the liquid.

In this example, the processing apparatus then transitions into a cooling stage once the first time expires. In the cooling stage, the processing apparatus slows the rotary motor to a second target speed of ˜90 rpm and sets a second timer for a duration of 270 seconds, thereby allowing contents of the cup to cool and begin to gel. While the second timer counts down, the processing apparatus rotates the beater 130 at this reduced speed to allow disordered polymer chains in the thickening hydrocolloid to begin to entangle, thereby thickening the suspension. This second target beater speed also allows milk proteins (e.g., casein) in the suspension to begin to clump in the presence if acidic solution, thereby gelling the suspension.

The processing apparatus then transitions into a freezing stage once: a temperature reading from a temperature sensor in the processing apparatus indicates that contents of the first cup have dropped below a first target temperature (e.g., 0° C.) and less than 180 seconds remain on the second timer; a torque output of the rotary motor necessary to maintain a speed of 90 rpm indicates that the contents of the first cup have reached a first target viscosity of 3.5 centipose and less than 180 seconds remain on the second timer; or the second timer has expired. In the freezing stage, the processing apparatus further slows the rotary motor to a third target speed of ˜710 rpm and sets a third timer for a duration of 210 seconds, thereby allowing contents of the cup to begin to freeze and thicken. In particular, this third, slower speed of the beater 130 may allow ice crystals to form on the interior wall of the first cup; the beater 130 scrapes these ice crystals from the interior wall of the first cup and mixes these ice crystals into the bulk contents of the first cup. Like the first and second target beater speeds, this third target beater speed continues to break clumps of powder and prevents clumping of milk proteins in the acidic suspension.

The processing apparatus then transitions into a deep-freezing stage, such as once: a torque output of the rotary motor necessary to maintain a speed of 90 rpm indicates that the contents of the first cup have reached a second target viscosity of 4.2 centipose and less than 150 seconds remain on the third timer; or the third timer has expired. In the deep-freezing stage, the processing apparatus can set a fourth timer to 30 seconds. Once the third timer expires, the processing apparatus transitions into a hardening stage, reduces the motor speed to 50 rpm, and sets a fourth timer for 15 seconds. Furthermore, once the fourth timer expires, the processing apparatus transitions into a smoothing stage, sets a timer for 15 seconds, and increases the motor speed to 175 rpm, which make break long polymer chains in the suspension in the cup, thereby smoothing the suspension to achieve a target mouth feel and texture.

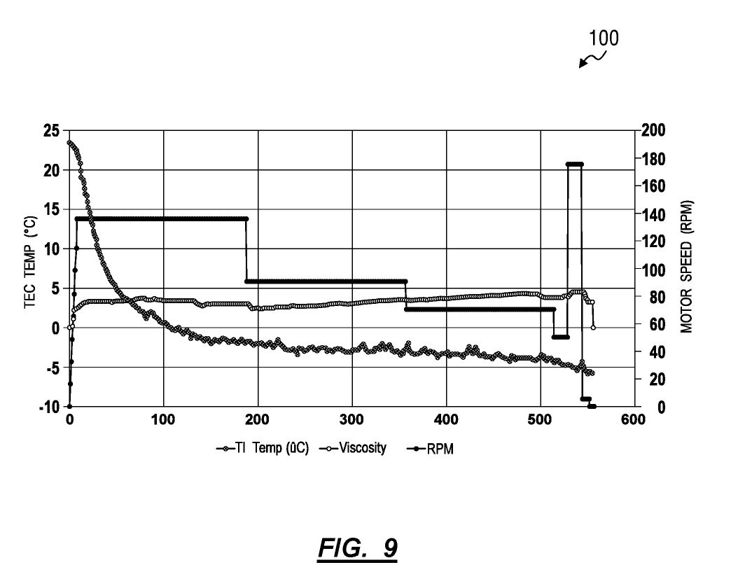

Finally, once the fifth timer expires, the processing apparatus can enter a holding stage and indicate that the frozen food product is ready for consumption, such as by flashing a light or sounding an audible alert. In this holding stage, the processing apparatus can reduce the beater speed (e.g., to 10 rpm or to a stop) and/or reduce the duty of the refrigeration unit (e.g., to 50% or to null), as shown in FIG. 9, in order to maintain the state of the contents of the first cup, such as if the user is not immediately available to retrieve the first cup and consume its contents.

In this example, like the first cup, a second cup defines a drawn or spun aluminum container, includes a nylon beater, and includes a foil-backed lid that seals a volume of roasted dry powder mix 140 within the second cup. In this example, the roasted dry powder mix 140 includes: conjointly freeze-dried honey and yogurt cultures; sugar; gelling-type hydrocolloid; thickening-type hydrocolloid; and dry cocoa powder. The second cup and its contents (a “second serving unit 100”) can be distributed, sold, and stored with the first cup, such as in a variety pack (e.g., the “serving kit 200”), as shown in FIG. 2. To prepare the contents of the second cup for consumption (e.g., some time after the first cup is processed), the user peels the lid from the second cup, adds a liquid to the second cup up to an indicated fill line, inserts the second cup into the receptacle in the processing apparatus, and selects a “Start” button on the processing apparatus. As described above, in response to selection of the “Start” button, the processing apparatus can activate the refrigeration unit, couple the rotary motor to the beater 130, and ramp the rotary motor from stationary to a first target speed of 150 rpm. The processing apparatus can then execute a sequence of processing steps as described above to transform the dry roasted mix and the added liquid into a frozen food product.

In particular, as the second cup is processed, the rotary motor can rotate the beater 130 at a first target speed: to break clumps of sugar, gelling hydrocolloid, thickening hydrocolloid, yogurt powder, and/or cocoa powder; to distribute these components throughout the liquid as the cup 110 and its contents cool; and to force rehydration of the dry cocoa and hydrocolloid powders during the mixing stage. The processing apparatus can continue this process into the cooling stage by reducing the motor speed to 90 rpm and setting the second timer to 270 rpm. Generally, because dry cocoa powder may by hydrophobic (i.e., exhibit a bias toward hydrophobicity), the processing apparatus can rapidly rotate the beater 130 in order to stir the dry cocoa powder into the liquid and to force rehydration of the cocoa powder before water in the second cup freezes, thereby reducing proportions of dry cocoa powder and “free” ice particles that may yield weaker flavor and rougher texture in the resulting suspension, respectively. Hydrocolloids may also exhibit hydrophobic biases; by rapidly mixing the dry powder mix 140 and added liquid, the processing apparatus can similarly ensure that a minimal proportion (e.g., 95%) of hydrocolloids in the dry powder mix 140 are fully rehydrated before water in the cup 110 begins to freeze.

After the second timer expires, once the contents of the cup 110 have reached the first target temperature, and/or once contents of the cup 110 have reached the first target viscosity, the cocoa powder and powdered hydrocolloids may be sufficiently mixed into the liquid and (re)hydrated, and the processing apparatus can reduce the speed of the beater 130 (e.g., to the third target speed of ˜70 rpm) during a freezing stage in order to allow ice crystals to form in the second cup. However, at the third target speed, the beater 130 can rotate at a speed sufficient to break large networks of entangled thickening hydrocolloids, interlinked gelling hydrocolloids, and small clumps of powder mix, thereby limiting thickening and gelling of the suspension while ice forms in the second cup. At the third target speed, the beater 130 can also break large ice crystals while enabling small ice crystals to remain such that the completed suspension exhibits a smooth texture.

After the third timer expires, once the contents of the cup 110 have reached the second target temperature of −1° C., and/or once contents of the cup 110 have reached the second target viscosity, the processing apparatus can: enter the deep-freezing stage for 15 seconds; and then reduce the speed of the beater 130 (e.g., to the fourth target speed of ˜50 rpm) for 15 seconds during the hardening stage, which reduces shearing of entangled thickening hydrocolloids and interlinked gelling hydrocolloids and allows hydrocolloid networks and junctions to persist, thereby thickening and gelling the suspension. Once the hardening stage is completed, the processing apparatus increases the speed of the motor to 175 rpm for 15 seconds during a smoothing stage in order to smooth the suspension. Finally, once the smoothing stage is complete, the processing apparatus can slow the beater 130 to a final target speed of ˜10 rpm and reduce the power output of the refrigeration unit, as described above, in order to maintain the state of the contents of the second cup until the user is available to retrieve the second cup from the processing apparatus.

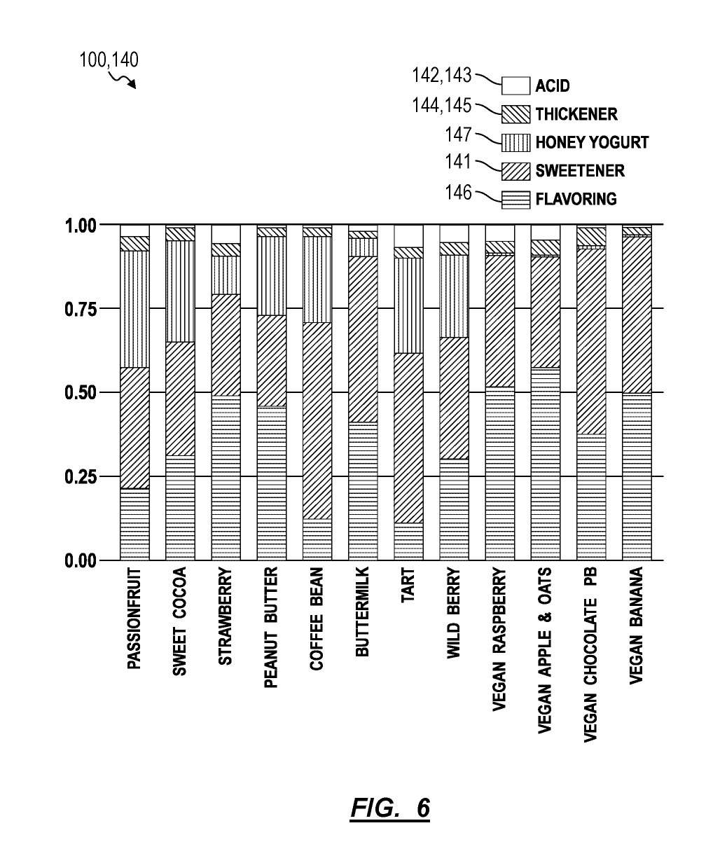

Therefore, a quantity of fruity dry powder mix 140 and a quantity of roasted dry powder mix 140 can contain quantities of sweetener 141, thickening hydrocolloid, gelling hydrocolloid, acid, yogurt powder, and/or flavoring, as shown in FIG. 6, such that: fruity and roasted dry powder mixes can be stored and processed in like (e.g., substantially identical) cups; and fruity and roasted dry powder mixes can be processed according to like processing cycles executed by a processing apparatus without knowledge of or compensation for a type of dry powder mix 140 contained in a cup 110 loaded into the processing apparatus.

Furthermore, the fruity and roasted dry powder mixes can include quantities of sweetener 141, thickening hydrocolloid, gelling hydrocolloid, acid, yogurt powder, and/or flavoring that transform into an edible, thickened, and gelled food product when mixed and cooled with any number of distinct liquid types, such as whole milk, 2% milk, skim milk, soy milk, almond milk, or water. For example, when a quantity of whole milk is added to a cup 110 containing fruity dry powder mix 140 and the cup 110 is processed according to the processing cycle described above: less total water in the cup 110 can yield fewer ice crystals when cooled; acid in the fruity dry powder mix 140 can coagulate casein in the milk and yogurt powder; and fat in the milk can improve dispersion of hydrocolloids, thereby increasing the coagulation, thickening, and gelling of food product and compensating for the lower total water content in the cup 110. However, when water is added to a similar cup containing fruity dry powder mix 140 and the cup 110 is processed according to the processing cycle described above: only milk protein in the yogurt powder is available to coagulate in the presence of acid and the dry powder mix 140, thereby yielding reduced gelling; more total water in the cup 110 yields more ice crystals when cooled, which compensates for lack of gelled milk proteins; and an higher concentration of water in the cup 110 yields greater hydration access for hydrocolloids, thereby compensating for lack of proteins and fats in the cup 110 and improving thickening of the processed food product in the cup 110. Therefore, while an amount of a dry powder mix 140 processed with whole milk may be creamier and less icy than another amount of the dry powder mix 140 processed with water: soft, flavorful suspensions may result from both amounts of the dry powder mix 140.

Furthermore, a third cup containing a vegan or dairy-free dry powder mix, such as shown in FIG. 6, can be processed into a frozen dessert according to a similar sequence of stages and similar time-, temperature-, and/or viscosity-based triggers.

5. Pre-Packaged Food Storage and Preparation Vessel

The pre-packaged food storage and preparation vessel includes: a cup 110 defining a cavity and configured to engage a cooled receptacle within a frozen food processing apparatus; a beater 130 configured to rotate within the cavity and including a drive coupling 133 configured to engage a motorized shaft extending from the frozen food processing apparatus over the cooled receptacle; and a seal 120 transiently arranged over the cavity and transiently sealing the beater 130 and a quantity of dry powdered food product 146 within the cavity. Generally, a cup 110: is configured to store a quantity of dry powder mix 140 until selected by a user for processing; functions as a container in which the quantity of dry powder mix 140 is mixed, beaten, and cooled with an added milk product to produce a serving of frozen yogurt; and functions as a container from which the serving of frozen yogurt may be consumed directly by the user. The beater 130 functions to mix, beat, and/or whip contents of the cup 110 as the cup 110 is processed by a processing apparatus; and the seal 120 functions to enclose and seal (e.g., hermetically seal) the dry powder mix 140 and the beater 130 within the cup 110 until the cup 110 is selected for processing.

A first cup containing a fruity dry powder mix 140 and a second cup containing a roasted (or “nutty”) dry powder mix 140 can define substantially similar (e.g., substantially identical) geometries; a first beater and a second beater stored in the first and second cups can also define substantially similar geometries. In particular, a single cup geometry and a single common beater geometry can be implemented for storing and processing multiple unique dry powder mix 140 flavors, wherein each dry powder mix 140 contains a substantially unique combination of sweetener 141, thickener 144 (e.g., hydrocolloid, gelling agent or activator), yogurt powder, and/or flavor, etc.

5.1 Cup

As shown in FIGS. 5A, 5B, and 5C, the cup 110 can define a unitary structure including: a wall 111 defining a frustoconical section revolved around a central axis and declined toward the central axis; a base 112 extending from a lower edge of the wall 111 toward the central axis; and a rim 113 extending laterally from the frustoconical section opposite the base 112. Generally, the cup 110 is symmetric about the central axis and supports rotation of the beater 130 about the central axis such that the beater 130 remains in alignment with the motorized shaft of the processing apparatus while scraping the interior surfaces of the cup 110 during a processing cycle.

In one implementation, the wall 111 of the cup 110 is tapered downward toward its central axis and terminates in the base 112 to form a frustoconical section. For example, the wall 111 of the cup 110 can define a thin, straight cross-section declined at a draft angle of 15° toward the central axis of the cup 110 and swept radially about the central axis of the cup 110 to form a 30° cone angle. However, the cup 110 can define any other draft angle (or “conical angle”) such as between 0° and 15°. In particular, the wall 111 of the cup 110 can define a tapered (or “drafted,” “conical”) geometry configured to mate with the cooled receptacle of the processing apparatus such that a substantially large portion of the exterior surface of the wall 111 of the cap contacts the internal surface of the receptacle, thereby achieving high thermal contact and high thermal conductivity between the cup 110 and the receptacle. Because the wall 111 of the cup 110 defines a conical section, the cup 110 may inherently seat and center in the receptacle. The motorized driveshaft of the processing apparatus can be weighted or actively driven downward by the processing apparatus to further depress the cup 110 into the receptacle and to improve thermal contact between the cup 110 and the receptacle. However, the wall 111 of the receptacle can also define a conical angle sufficiently wide to prevent the wall 111 of the cup 110 and the interior surface of the receptacle from binding; that is, the wall 111 of the cup 110 can define a conical angle matching a conical angle of the receptacle according to a self-releasing taper angle.

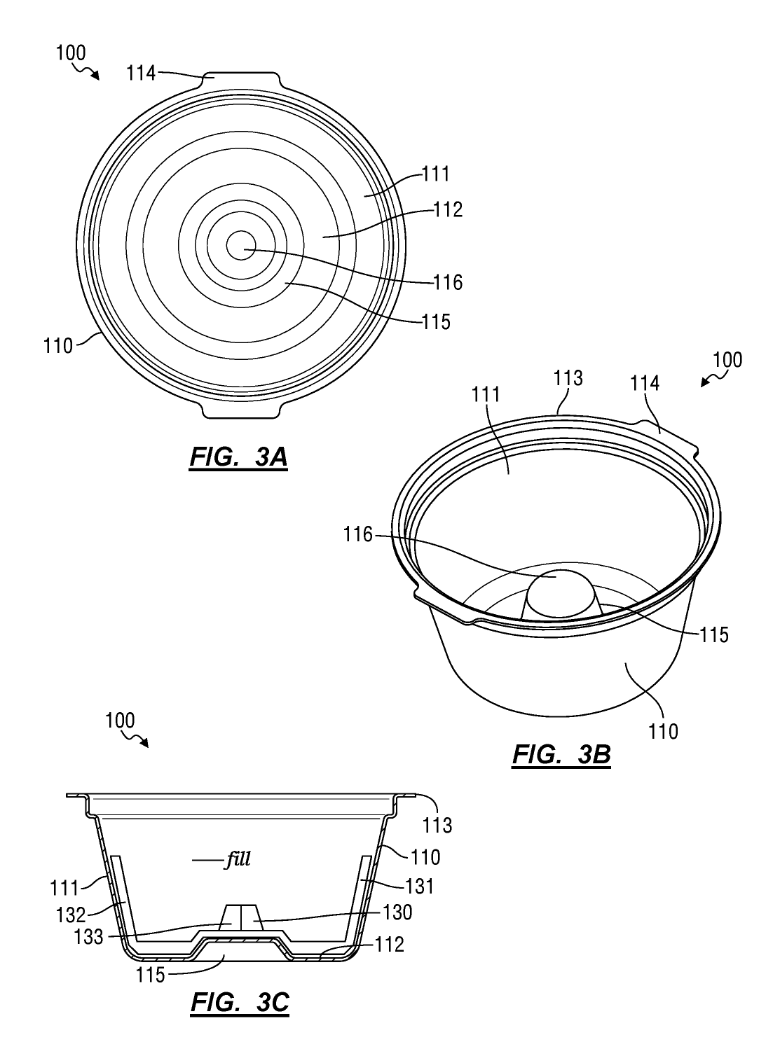

Furthermore, as shown in FIGS. 3A, 3B, and 3C, the rim 113 of the cup 110 defines an engagement feature, such as a receptacle, slot, hook, serrated or stepped edge, tab, or other locking feature 114 configured to engage a complementary fixed feature integrated into or extending from the rim of the receptacle of the processing apparatus in order to prevent rotation of the cup 110 in the receptacle during a processing cycle. Thus, when the cup 110 is inserted into the receptacle, the locking feature 114 defined by the rim 113 of the cup 110 can engage the complementary feature adjacent or integrated into the receptacle, which prevents the cup 110 from rotating within the receptacle during the processing apparatus.

The wall 111 of the cup 110 can additionally or alternatively define a conical angle configured to wedge into and to bind against the receptacle; that is, the wall 111 of the cup 110 can mate with the receptacle according to a self-holding taper interface, as shown in FIG. 8. In this variation, the drive unit can drive the cup 110 into the receptacle to ensure sufficient binding between the cup 110 and the receptacle to prevent rotation of the cup 110 during a processing cycle. In this variation, the processing apparatus can include a plunger arranged in the receptacle and configured to drive the cup 110 upward, thereby releasing the cup 110 from the receptacle upon completion of a processing cycle. For example, the plunger can be manually or electromechanically actuated upon completion of a processing cycle; when actuated, the plunger can depress the base 112 of the cup 110 upward, thereby deforming the base 112 of the cup, drawing a portion of the wall 111 of the cup 110 inward and away from the adjacent surface of the receptacle, and releasing the cup 110 from the receptacle.

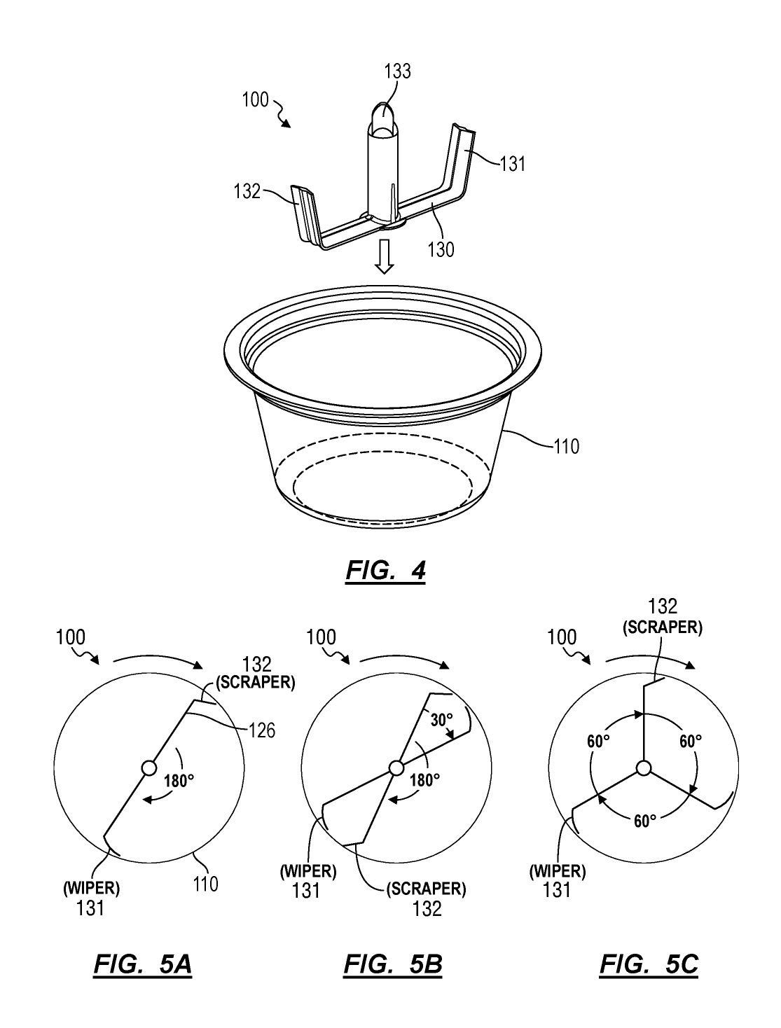

The base 112 defines a “bottom” of the cup 110 and extends from the wall 110 toward the central axis of the cup 110. In one implementation, the base 112 defines a substantially flat or planar surface extending from the bottom edge of the wall 111 to the axial center of the cup 110; and a section of the beater 130 configured to mate with the base 112 of the cup 110 that defines a like (e.g., planar) geometry, as shown in FIG. 4.

Alternatively, the cup 110 can include a (frustoconical) stanchion 115, centered over the central axis, extending upward toward the upper edge of the wall 111, and configured to locate the drive coupling 133 in coaxial alignment with the central axis; the base 112 can extend from the lower edge of the wall 111 to the lower edge of the stanchion 115, as shown in FIG. 1. In this variation, the stanchion 115 can define a frustoconical riser centered on the central axis of the cup 110, extending above the base 112, and terminating in a shelf offset below the rim 113 of the cup 110. The shelf can define a bearing surface 116 that vertically supports the drive coupling 133 of the beater 130 against downward force applied by the driveshaft of the processing apparatus during a processing cycle. For example, the stanchion 115 can taper upwardly toward the central axis of the cup 110 to form a conical angle substantially identical to that of the wall 111 of the cup 110 (e.g., 30°. However, the stanchion 115 and the wall 111 of the cup no can form any other similar or dissimilar conical angle(s).

In one implementation, the shelf extends from the base 112 upward toward the rim 113 of the cup 110 and terminates at or (slightly) above a liquid fill line indicated by the cup 110. In this implementation, the drive coupling 133 of the beater 130 can be configured to rest on (e.g., mate with) the shelf defined at the top of the stanchion 115, and blades of the beater 130 can extend down the side of the stanchion 115, across the base 112, and up the interior surface of the wall 111. Because the interface between the drive coupling 133 and the shelf is located above the liquid fill line, liquid and then ice crystals and frozen suspension may not collect (or “build up”) between the shelf and the drive coupling 133 during a processing cycle, which may otherwise elevate the beater 130 within the cup 110 and reduce scraping efficiency of the blades. In particular, the beater 130 functions to scrape ice crystals from the interior wall of the cup 110, but effectiveness of the beater 130 may decrease if material—such as ice crystals and/or rehydrated fruit particles—collect between the drive coupling 133 of the beater 130 and the shelf of the stanchion 115, which may raise the beater 130 within the cup 110 and offset the blades from the wall 111 of the cup 110. The stanchion 115 can therefore define the shelf above the liquid fill line of the cup 110 in order to substantially isolate the interface between the shelf and the drive coupling 133 of the beater 130 from wet and dry food products contained in the lower volume of the cup 110. In particular, when liquid is added to dry powder mix 140 in the cup 110 and the cup 110 subsequently processed in the processing apparatus, the liquid, thickened solution, and/or then frozen suspension in the cup 110 may remain below the shelf, thereby preventing collection of such material over the shelf.

Alternatively, the stanchion 115 can define the shelf (or bearing surface 116) below the indicated fill line. For example, the stanchion 115 can define a short dimple coaxial with the central axis on the base 112, as shown in FIGS. 3B and 3C. In this example, the dimple can define a convex frustoconical or semispherical form that constrains the beater 130 below the drive coupling 133 coaxially within the cup 110, such as while the serving unit 100 is in transit, while a user removes the seal 120, and while the driveshaft of the processing apparatus lowers to engage the beater 130 such that the drive coupling 133 is suitably aligned with the driveshaft for engagement. Furthermore, in this example, the dimple can function to constrain the drive coupled against the driveshaft while the beater 130 rotates during a processing cycle.

The cup 110 can also define a fillet between the wall 111 and the base 112 (and between the base 112 and the stanchion 115). In this implementation, the fillet(s) can be sized to enable tips of spoons of common geometries to be manipulated into and across the fillet. For example, each fillet can define a fillet radius of 0.375″. The external wall 111 of the cup 110 can also define a stack ring adjacent the rim 113. For example, the external wall 111 of a first cup can define a 0.15″ by 0.15″ step with shallow draft angle (e.g., ˜2°) offset 0.10″ below the rim 113 of the first cup and configured to vertically offset a second cup placed inside the first cup.

The wall 111, base 112, rim 113, and stanchion 115 of the cup 110 can define a unitary structure of a substantially thermally conductive material. For example, the wall 111, base 112, rim 113, and stanchion 115 can be stamped, drawn, hydro-formed, or spun from aluminum sheet between 0.015″ and 0.050″ thick; following this forming process, the rim 113 of the structure can be punched, die cut, or laser-cut to form one or more locking features 114, as described above. However, the structure of the cup 110 can define any other geometry or feature and can be of any other material formed in any other way.

In one variation, the cup 110 includes an inert coating applied to the interior surface of the cup 110 (e.g., across a contiguous interior surface spanning the base 112, the wall 111, and the rim 113. For example, the interior surface of the cup 110 can be coated with a transparent or translucent polyester coating or other polymeric coating to prevent dry powder mix 140 contained in the cup 110 from reacting with and/or sticking to the bare (aluminum) interior surface of the cup 110. However, the interior surface of the cup 110 can be coated with any other material suitable for: reducing stiction between the material of the cup 110 and dry or rehydrated powder mix contained therein; and/or preventing reaction between the base 112 material of the cup no and dry or rehydrated powder mix, which may otherwise give the completed suspension a metallic taste.

5.2 Fluid Level Indicator

As described above, the cup 110 can include a stanchion 115 that defines a shelf indicating a fluid fill level; in preparation for a processing cycle, a user can thus fill the cup 110 with a liquid (e.g., whole milk, almond milk) up to the top of the stanchion 115. Alternatively, the wall 111 of the cup 110 can include a visual indicator of a fluid fill level, as shown in FIG. 3C. For example, a fluid fill level indicator can be printed onto the interior surface of the vessel with a food-safe ink or applied under a translucent food-safe coating applied to the interior surface of the cup 110. In another example, a fluid fill level indicator can be chemically etched or laser-etched onto the interior surface of the cup 110. Yet alternatively, a fluid fill level indicator can be can embossed or debossed into the wall 111 of the cup 110.

However, the cup 110 can visually indicate a fluid fill level for the cup 110 in any other way.

5.3 Beater

The beater 130 is arranged within the cavity, is configured to rotate about the central axis of the cup 110, and includes: a first blade 131 configured to extend along the base 112 and up a portion of the wall 111; a second blade 132 radially offset from the first blade 131 and configured to extend along the base 112 and up a portion of the wall 111; and a drive coupling 133 interposed between the first blade 131 and the second blade 132 and extending opposite the base 112. Generally, the beater 130 defines a loose member arranged inside the cup 110 and configured to scrape dry and wet food product from the interior surfaces of the cup 110 during a processing cycle. In particular, the beater 130 includes: a drive coupling 133 configured to mate with (e.g., rest on) a bearing surface 116 defined over the axial center of the base 112 or over a shelf defined by a stanchion 115 and configured to rotate about the central axis of the cup 110; a first blade 131 extending from the drive coupling 133, (down an inclined surface of the stanchion 115,) along the base 112, and up a portion of the wall 111; and a second blade 132 radially offset from the first blade 131 and extending from the drive coupling 133, (down an inclined surface of the stanchion 115,) along the base 112, and up a portion of the wall 111. The beater 130 can include one or more additional blades, such as a total of three blades spaced equidistant about the drive coupling 133.

In one implementation, the drive coupling 133 defines an internal or external spline configured to mate with an externally- or internally-splined end of a driveshaft of the processing apparatus. The drive coupling 133 of the beater 130 can define an internal or external tapered splined tip narrowing toward the top of the beater 130 vertically and radially and configured to self-align with the externally- or internally-splined end of the driveshaft as the driveshaft is lowered toward the receptacle in preparation for a processing cycle. However, the drive coupling 133 of the beater 130 can define any other form or geometry configured to mate with a complementary form at the end of the driveshaft.

In one implementation, the beater 130 includes a pair of blades extending from the drive coupling 133 and radially offset by 180° about the drive coupling 133. Each blade can define a scraper-type cross-section swept along a path matched to the interior surfaces of the base 112 and the wall 111 (and the stanchion 115) of the cup 110. For example, in the implementation described above in which the cup 110 includes a stanchion 115, each blade of the beater 130 can include three linear sections separated by two arcuate sections, wherein a first linear section runs down the stanchion 115, a first arcuate section runs along an inner fillet between the stanchion 115 and the base 112, a second linear section runs along the base 112 (e.g., along the floor of the cup 110), a second arcuate section runs along an outer fillet between the base 112 and the wall 111, and a third linear section runs up the wall 111.

In the foregoing implementation, an angle between the first and second sections and an angle between the second and third sections of each blade can exceed an angle defined by the stanchion 115 and the base 112 and by the base 112 and the wall 111 of the cup 110, respectively, such that the blades elevate the drive coupling 133 off of the stanchion 115 (i.e., separate the drive coupling 133 from the adjacent bearing surface 116) when at rest. However, when the serving unit 100 is placed in a processing apparatus and a driveshaft engages and depresses the drive coupling 133 downward, the arcuate sections of the blade can deform into the cup 110 and compress against the interior surface of the cup 110, thereby increasing efficiency of leading edges of the blades in scraping liquid and frozen material from the interior surfaces of the cup 110 during a processing cycle.

Each section of each blade can thus scrape ice crystals from interior surfaces of the cup 110 as the processing apparatus cools the cup 110 during a processing cycle, thereby preventing collection of ice crystals on the cup 110 and preventing growth of larger ice crystals that may otherwise result in a rougher texture and less pleasant mouth feel of the frozen suspension upon conclusion of the processing cycle. Furthermore, when rotated, the blades of the beater 130 can also cooperate to draw ice crystals formed on the wall 111 of the cup 110 toward the center of the cup 110 such that these ice crystals may mix with and cool other contents of the cup 110.

In one implementation, the first blade 131 includes a wiper section configured to extend up a portion of the wall 111 and to wipe rehydrated volumes of the dry powder mix 140 onto the interior surfaces of the wall 111; and the second blade 132 includes a scraper section configured to extend up a portion of the wall 111 and to scrape frozen layers of rehydrated volumes of the dry powdered food product 146 off of the wall 111. In this implementation, the wiper section can define an edge that trails the beater 130 when rotated by the processing apparatus such that the wiper section deposits (or “wipes”) contents onto the interior wall of the cup 110, as shown in FIGS. 5A-5C. The wiper section can include tabs that ride on the interior wall of the cup 110 to set and maintain an offset (e.g., 0.05″) between the trailing edge of the wiper section and the interior wall of the cup 110 in order to control a thickness of a layer of the suspension deposited onto the interior surface of the cup 110 as the suspension freezes during a processing cycle. The scraper section can define an edge that leads the beater 130 when rotated by the processing apparatus such that the scraper section removes (or “scrapes”) cooled or frozen material off of the wall 111 of the cup 110 and mixes this material back into the main volume of the suspension near the center of the cup 110 as the processing apparatus rotates the beater 130. The first blade 131 containing the wiper section and the second blade 132 containing the scraper section can be radially offset about the drive coupling 133 by a phase angle sufficient to enable contents wiped onto the interior of the cup 110 to cool and/or freeze by a sufficient amount before being scraped off the surface of the cup 110 and returned to the bulk volume of the suspension and sufficient to prevent growth of large ice crystals on the wall 111 of the cup 110 before being scraped from the wall 111 given a target beater speed and cooling rate throughout various predefined stages of a processing cycle.

In one example of the foregoing implementation, the first blade 131 defining the wiper section and the second blade 132 defining the scraper section are offset by 180° about the drive coupling 133 to form a symmetrical arrangement of blades when viewed along the central axis of the cup 110, as shown in FIG. 5A. In another example, the first blade 131 is radially offset ahead of the second blade 132 by 60° to from an asymmetric blade arrangement. In this example, given a common beater speed, the symmetrical, 180° offset arrangement of the blades may allow rehydrated dry powder mix 140 and an accompanying liquid in a cup 110 to remain in contact with the interior wall of the cup 110 approximately three times longer per rotation of the beater 130 than the asymmetrical, 60° offset arrangement of the blades. In this example, the 180° offset arrangement of the blades can thus allow the suspension approximately three times as much time to transfer heat to the interior surface of the cup 110 and to freeze than the 60° offset arrangement of the blades with the scraper blade trailing the wiper blade.

The beater 130 can also include additional blades defining wiper and/or scraper sections. For example, the beater 130 can include: a first blade 131 defining a wiper section; a second blade 132 defining a first scraper section radially offset from the wiper section by 60°; and a third blade defining a second scraper section radially interposed between the first blade 131 and the second blade 132, as shown in FIG. 5C. In another example, the beater 130 can include: a first blade 131 defining a first wiper and a second blade 132 defining a first scraper and radially offset from the first blade 131 by 30°; and a third blade defining a first wiper and a fourth blade defining a second scraper and radially offset from the third blade by 30°, wherein the third blade is radially offset from the first blade 131 by 180°, as shown in FIG. 5B.

In one example, the beater 130 can include an injection-molded, disposable polymer, such as a fiber-filled food-safe nylon. However, the beater 130 can define any other suitable geometry, be constructed of any other material, and include any other number and type of blades.

5.4 Seal

As shown in FIG. 1, the serving unit 100 also includes a seal 120 that, when installed over the cup 110, seals the dry powder mix 140 and the beater 130 within the cup 110 and cooperates with the cup 110 to seal the dry powder mix 140 and the beater 130 from air, humidity, light, and/or dirt ingress. In one implementation, the seal 120 includes a metallic (e.g., aluminum) foil sheet bonded to the rim 113 of the cup 110 with a time, temperature, pressure, and/or UV-curable and food-safe adhesive. To prepare the cup 110 for processing, a user can peel the seal 120 from the cup 110, add a milk product to the cup 110, and then install the cup 110 in the receptacle of the processing apparatus.

Alternatively, the seal 120 can include a transparent or translucent polymer film applied across the rim 113 of the cup 110 and configured to be punctured by the driveshaft when the driveshaft of the processing vessel is deployed downward to engage the drive coupling 133 on the beater 130. The seal 120 can thus prevent liquid from escaping the cup 110 during a processing cycle but can also—by nature of its translucency—enable a user to view transition of contents of the cup 110 from liquid to frozen during the processing cycle. For example, the driveshaft can be configured to pierce the translucent seal at the beginning of a processing cycle. Alternatively, the cup 110 can include a secondary (translucent or opaque) seal over the center of the (primary) seal; a user can remove the secondary seal to expose an opening in the primary seal coincident the central axis of the cup 110, pour liquid into the cup 110 through the opening, and then install the cup 110 into the processing apparatus. In this example, the driveshaft can thus pass through the opening in the primary seal to engage the drive coupling 133, and the primary seal can remain in place over the path of the tips to prevent splatter of food product from the tips of the blades during the subsequent processing cycle.

However, the seal 120 can include any other material of any other geometry transiently (i.e., removably) installed across the rim 113 of the cup 110. For example, the seal 120 can include a foil-backed, polymer-impregnated paper lid. In the implementation described above in which the cup 110 includes one or more locking features 114, the seal 120 can extend over but remain separate from (i.e., unbounded to) the locking features 114 in order to enable a user to grasp and peel the seal 120 from the rim 113 of the cup 110.

The cup 110, beater, and seal can thus define a single container in which an amount of dry powder mix 140: is stored; then, when ready for consumption, is mixed with liquid, cooled, and beaten to create a volume of frozen yogurt; and finally consumed by a user. Once the volume of frozen yogurt is consumed, the cup 110 and beater (along with the seal 120) can be discarded (e.g., recycled), thereby necessitating no further cleanup of the processing apparatus.

Alternatively, the cup 110 and beater can be reusable. For example, after a first use in which the seal 120 is peeled from the cup 110 and discarded, the beater 130 and cup can be washed. To reuse the beater 130 and cup, a user can insert the beater 130 into the cup 110, dispense a packet of dry powder mix 140 into the cup 110, add a liquid to the cup 110, and place the cup 110 into the processing apparatus. The processing apparatus can then process the contents of the cup 110, as described above. Therefore, dry powder mix 140 can be packaged separately into a packet and provided separately from a reusable or disposable cup 110 and beater 130.

Furthermore, the seal 120 can seal dry mix powder 140 inside the cup 110, and the beater 130 can be packaged outside of the cup 110, such as taped or glued to the exterior of the seal 120. In this implementation, a user can: separate the beater 130 from the cup 110 or seal 120; remove the seal 120 from the cup 110; place the beater 130 into the cup 110; fill the cup 110 with milk or other liquid; and then place the cup 110 into the processing apparatus from processing into a cup of frozen yogurt.

6. Dry Powder Mix

The serving unit 100 can also include an amount of dry powder mix 140—including a first quantity of flavoring 146, a second quantity of sweetener 141, and a third quantity of thickener 144—packaged and sealed within the beater 130 in the cup 110. As shown in FIG. 6, a first “fruity” dry powder mix 140 can include: a first proportion of dried fruit particles; a first proportion of citric acid 142 matched to the first proportion of dried fruit particles; a first proportion of a second acid 143 distinct from citric acid, the first proportion of the second acid 143 configured to cooperate with the first proportion of citric acid 142 to gel a portion of milk proteins in a volume of milk product added to the first cup; a first proportion of thickening hydrocolloid 145 in the disperse phase and configured to rehydrate in the presence of the volume of milk product added to the first cup and to form a network of polymer chains; a first proportion of powdered yogurt 147; and a first proportion of sweetener 141. However, as shown in FIG. 6, a second “roasted” dry powder mix 140 in the serving kit 200 can include: a second proportion of sweetener 141; a second proportion of dried ground nut particulate (greater than the first proportion of dried fruit particles); a second proportion of gelling hydrocolloid; a second proportion of thickening hydrocolloid 145—greater than the first proportion of thickening hydrocolloid 145—in the disperse phase, configured to rehydrate in the presence of a volume of milk product added to the second cup, and to form a network of polymer chains; and a second proportion of powdered yogurt 147.

6.1 Thickening Hydrocolloid

Generally, when liquid is added to dry powder mix 140 in a cup 110 and processed (e.g., in a processing apparatus), thickening hydrocolloid polymers in the dry powder mix 140 rehydrate and then thicken the resulting suspension by forming long polymer chains. In particular, rehydrated thickening hydrocolloid polymers can form a viscous dispersion within the cup 110 through non-specific entanglement of conformationally disordered polymer chains. For example, a dry powder mix 140 can include up to 10% by mass of one or more of starch, xanthan, guar gum, locust bean gum, gum karaya, gum tragacanth, gum Arabic, and/or a cellulose derivative.

The total quantity of thickening hydrocolloid in the dry powder mix 140 can correspond to a target fluid volume represented by the fluid fill level indicator of the cup 110. In particular, the total quantity of thickening hydrocolloids in the dry powder mix 140 can be sufficient to yield a total concentration of thickening hydrocolloids above an overlap concentration (“C*”)—specific to the thickening hydrocolloid or thickening hydrocolloid blend contained in the dry powder mix 140—when water is added to the cup 110 up to the fluid fill level indicator. Therefore, the overlap concentration for the thickening hydrocolloid(s) can be achieved for any edible liquid—such as water, juice, skim milk, whole milk, or cream, which may have the lowest concentration of water—added to the cup 110 up to (or near, such as +/−5% of) the fill level indicator such that thickening hydrocolloids in the suspension can entangle and thicken the suspension.

In one implementation, the dry powder mix 140 includes a quantity (e.g., 1.5-2% by mass) of pregelatinized, cold water swelling, modified food starch derived from tapioca, as shown in FIG. 6. Because this first thickening hydrocolloid is cold water swelling, the first thickening hydrocolloid can hydrate even when cooled in a processing apparatus. The first thickening hydrocolloid can also exhibit acid stability, such as in the presence of lactic acid in yogurt powder in both fruity and roasted dry powder mixs and in the presence of citric acid 142 and lactic acid in the fruity dry powder mix 140. Furthermore, because the first thickening hydrocolloid is pregelatinized (i.e., pre-exposed to liquid and then dried), the first thickening hydrocolloid can exhibit reduced tendencies to clump when exposed to liquid and cooled, thereby enabling a user to quickly dash liquid into the cup 110 without adversely affecting subsequent distribution of the first thickening hydrocolloid during a processing cycle. For similar reasons, the first thickening hydrocolloid can include organic guar gum with relatively high galactose content, which naturally swells and disperses in cold water. In this implementation, the proportion (or quantity) of the first thickening hydrocolloid can be selected to achieve a smooth, short, and glossy texture with creamy mouthfeel and minimal flavor alteration when a known volume of liquid is added to the cup 110 and beaten to form a frozen food product, as described above.

The dry powder mix 140 can additionally or alternatively include a quantity (e.g., 7-11% by mass) of a second thickening hydrocolloid exhibiting relatively high resistance to milling (e.g., “shear”) such that, when liquid is added to the dry powder mix 140 and beaten during a processing cycle, the second thickening hydrocolloid can begin to thicken the suspension at higher beater speeds. For example, the second thickening hydrocolloid can include locust bean gum or a pregelatinized, cold water swelling, modified food starch derived from waxy maize, as shown in FIG. 6. This second thickening hydrocolloid can also exhibit hydration, acid stability, mouthfeel, etc. similar to the first thickening hydrocolloid.

However, a roasted dry powder mix 140 can contain a greater proportion of hydrocolloids by mass than a fruity dry roasted powder mix in order to achieve sufficient thickening of the roasted dry powder mix 140 once processed despite lack of additional acids in the roasted dry powder mix 140. In particular, the roasted dry powder mix 140 can include a greater proportion of thickening hydrocolloid 145 per unit mass in order to achieve substantially similar thickening as a fruity dry powder mix 140 that includes acid that causes milk proteins to coagulate, gel, and thicken. Furthermore, the presence of sugars can increase shear strength of entangled hydrocolloid polymers; because the roasted dry powder mix 140 does not include fruit powder—which may otherwise contain sugar and pectin, a hydrocolloid naturally found in fruit—the roasted dry powder mix 140 can include a greater proportion of thickening hydrocolloid 145 per unit mass than the fruity dry powder mix 140 in order to achieve substantially similar shear strength in the suspension as the fruity dry powder mix 140 that includes powdered fruit. For example, a chocolate dry powder mix 140 can include ˜25% more of the first thickening hydrocolloid and the second thickening hydrocolloid by mass than a raspberry dry powder mix 140 but substantially similar proportions of dry honey and yogurt powder.

However, the fruity and roasted dry powder mixes can include any other one or more thickening hydrocolloids in any other similar or dissimilar proportions.

6.2 Gelling Activator and Gelling Agent

The fruity dry powder mix 140 can also include acid that functions to lower the pH of the suspension, thereby causing milk proteins (e.g., casein) in a volume of milk product—added to the cup 110 just before a processing cycle—to gel. In particular, the fruity dry powder mix 140 can contain a sufficient proportion of acid to neutralize at least a threshold fraction of negatively-charged proteins in a volume of milk product to the cup 110 added up to the fluid fill level indicator, thereby coagulating proteins in the volume of milk product and gelling the suspension.

The fruity dry powder mix 140 can include both powdered citric acid and powdered lactic acid that impart ‘fruit sour’ and ‘yogurt sour’ flavors to the suspension, respectively, as shown in FIG. 6. For example, the fruity dry powder mix 140 can include a proportion of citric acid 142 that achieves a target citrus sour level, such as ˜3% by mass of citric acid 142 in both blueberry and raspberry dry powder mixes. However, this proportion of citric acid 142 may be insufficient to fully coagulate milk proteins in the volume of added milk (e.g., at least a threshold of 90% of casein in the added milk). The fruity dry powder mix 140 can therefore also include a quantity of lactic acid that—when milk is added to the fruity dry powder mix 140 up to the fluid fill level indicator in a cup 110—cooperates with the citric acid in the fruity dry powder mix 140 to coagulate a sufficient amount of milk proteins to achieve a minimum true rupture stress of the suspension. In particular, because lactic acid is also present in the dry yogurt powder and exhibits a flavor profile complementary to yogurt, the fruity dry powder mix 140 can include additional powdered lactic acid that cooperates with the quantity of citric acid 142 to achieve a target acidity range in the suspension when a known volume of liquid is added to the cup 110 and without introducing a new or incompatible flavor profile to the suspension. In the foregoing example, both blueberry and raspberry dry powder mixes can include ˜2% lactic acid by mass.

Therefore, the total quantity of citric and lactic acid in a fruity dry powder mix 140 contained in a cup 110 can be matched to an amount of protein contained in a target volume of milk product to be added to the cup 110 in preparation for a processing cycle—that is, a volume of milk product equal to the volume defined by the fill level indicator in the cup 110 less the volume of fruity dry powder mix 140. For example, on average: one cup of whole milk may contain approximately 7.7 grams of protein; one cup of 2% milk can may contain approximately 8 g protein; one cup of 1% milk may contain approximately 8.2 grams of protein; one cup of nonfat milk may contain approximately 8.3 grams of protein per cup; and one cup of soymilk may contain approximately 7 grams of protein per cup. In this example, 16.5 grams of fruity dry powder mix 140 can contain a sufficient total amount of citric and lactic acids to gel 3 grams of proteins in 103.5 grams of soy milk added to the cup 110. If 103.5 grams of nonfat milk is instead added to the cup 110 prior to the processing cycle, this amount of citric and lactic acids can gel 3 grams of proteins in the 103.5 grams of nonfat milk, leaving approximately 0.5 gram of proteins in this amount of nonfat milk ungelled. Alternatively, the fruity dry powder mix 140 can include an amount of citric and lactic acids sufficient to fully gel all proteins in the nonfat milk and other protein-rich ground- and animal-based milk products added to the cup 110.

Alternatively, because citric acid intensifies fruit flavors, such as raspberry, grapefruit, and blueberry, the fruity dry powder mix 140 can include an amount of citric acid 142 flavor-matched to the proportion of dried fruit particles in the fruity dry powder mix 140 in order to achieve a target degree of citrus flavor in the resulting suspension. Also, because lactic acid intensifies a yogurt flavor, the fruity dry powder mix 140 can include an amount of lactic acid—in addition to the lactic acid in the dried yogurt powder—to achieve a target degree of yogurt flavor in the resulting suspension. Finally, because citric and lactic acids also cause proteins in an added milk product to gel, the fruity dry powder mix 140 can include a lower proportion of thickening (and gelling) hydrocolloid than the roasted dry powder mix 140 in order to compensate for the added gelling function of these acids.

However, the flavor profile of citric acid 142 may be incompatible with some roasted dry powder mix 140 flavors, such as chocolate, peanut butter, and coffee. Furthermore, excessive acidity with a roasted dry powder mix 140 flavor (e.g., more than 5% acid by mass) may be detrimental to the flavor of a suspension created with a roasted dry powder mix 140, such as chocolate-, peanut butter-, or coffee-flavored frozen yogurt. Therefore, a roasted dry powder mix 140 can exclude all (or some) additional citric and lactic acids otherwise incorporated into a fruity dry powder mix 140; the roasted dry powder mix 140 can instead include a gelling hydrocolloid and/or other additional thickening hydrocolloid over the fruity dry powder mix 140 in order to achieve similar gelling and thickening in a suspension created with the roasted dry powder mix 140. For example, a roasted dry powder mix 140 can include: alginate, pectin, carrageenan, gellan, gelatin, agar, modified starch, methyl cellulose, and/or hydroxypropylmethyl cellulose, in dry powdered form, such as between 0.5% and 0.8% by mass as shown in FIG. 6.

Generally, when liquid is added to roasted dry powder mix 140 in a cup 110, the gelling hydrocolloid in the roasted dry powder mix 140 functions to structure or “gel” the suspension by cross-linking to form a tangled and interconnected three-dimensional molecular network immersed in a liquid medium (e.g., milk, water). In particular, the gelling hydrocolloid polymer molecules can form conformationally-ordered junction zones though inter-chain association (e.g., cation mediated cross-linking of negatively charged polysaccharides) to achieve ionotropic gelation. Gelling hydrocolloids form junction zones at intersections of two or more molecules; junction zones that form from greater numbers of molecules yield more rigid gels but are more sensitive to shear and are less easily rebuilt when disturbed by shear forces. Therefore, the roasted dry powder mix 140 can include a gelling hydrocolloid that forms junction zones from a particular number (or range) of (e.g., 3-4) molecules matched to a second and/or third beater speed executed by the processing apparatus in order to achieve a flexible texture and robust gelation of the suspension despite shear forces induced by rotation of the beater 130 during processing. For example, the chocolate dry powder mix 140 can include 0.6% organic agar gum by mass such that both a cup 110 containing chocolate dry powder mix 140 and a cup 110 containing raspberry dry powder mix 140 can be processed according to the same processing schedule (e.g., timer, temperature threshold, viscosity, and/or beater speed parameters) to achieve suspensions exhibiting substantially similar rigidity and texture despite different gelation pathways that characterize the chocolate and raspberry dry powder mixes.

Furthermore, calcium in a milk product added to a cup 110 containing roasted dry powder mix can strengthen gelling hydrocolloid junctions. In particular, calcium atoms in the yogurt powder and/or in milk added to the cup 110 can bridge gelling hydrocolloid junctions and increase the rupture stress of the gel thus formed by gelling hydrocolloid. Therefore, milk added to a cup 110 containing roasted dry powder mix 140 includes calcium that can increase the rigidity of the suspension; whereas milk added to a cup 110 containing fruity dry powder mix 140 includes milk proteins (e.g., casein) that gel the suspension when exposed to acid in the fruity dry powder mix 140. Use of nonfat milk in both roasted and fruity dry powder mixes can therefore yield similarly gelled, high-rigidity suspensions.

However, when whole milk—which has less calcium and less protein than nonfat milk—is added to a cup 110 containing roasted dry powder mix 140, less calcium is available to bridge gelling hydrocolloid junctions, thereby yielding a less rigid suspension but creamier suspension. When whole milk is added to a cup 110 containing fruity dry powder mix 140, fewer milk proteins are available to gel in the suspension, thereby also yielding a less rigid but creamier suspension. Use of whole milk—rather than nonfat milk—in both roasted and fruity dry powder mixes can therefore yield similarly gelled, lower-rigidity, creamier suspensions as a result of greater fat content and weaker gelling. Similarly, when water is added to a cup 110 containing roasted dry powder mix 140, even less calcium is available to bridge gelling hydrocolloid junctions, thereby yielding an even less rigid suspension, though a higher proportion of free water may yield more free ice particles and a “rougher” texture of the suspension. When water is added to a cup 110 containing fruity dry powder mix 140, fewer milk proteins are available to gel in the suspension, thereby also yielding a less rigid suspension, though again a higher proportion of free water may yield more free ice particles and a “rougher” texture of the suspension. Use of water—rather than a ground- or animal-based milk product—in both roasted and fruity dry powder mixes can therefore yield similarly gelled, lower-rigidity, “rougher” suspensions. Therefore, fruity and roasted dry powder mixes can include different proportions of acids and hydrocolloids in order to achieve both recognizable flavors of target strength and similar mouth feels given addition of the same quantity of liquid for various liquid types (e.g., water, nonfat milk, low-fat milk, and whole milk) that may be combined with these dry powder mixes to create servings of frozen yogurt.

Alternatively, rather than incorporate a gelling hydrocolloid, the roasted dry powder mix 140 can include a higher proportion of thickening hydrocolloid 145, such as a blend of guar gum and locus bean gum, than a fruity dry powder mix 140 in order to compensate for a reduced proportion of acid in the roasted dry powder mix 140.

However, a fruity dry powder mix 140 can include any other type and proportion of one or more acids, and a roasted dry powder mix 140 can include any other type and proportion of one or more gelling and/or thickening hydrocolloids.

6.3 Yogurt Powder

The fruity and roasted dry powder mixes also include powdered yogurt 147 that yield a yogurt flavor once combined with a liquid and processed, as described above, to create a serving of frozen yogurt.

In one implementation, the powdered yogurt 147 is prepared in situ with honey to create a dry honey-yogurt powder 147. For example, a volume of wet yogurt can be prepared, wet honey can then be mixed into the volume of wet yogurt (e.g., at a ratio of one part wet honey to one part wet yogurt), and the honey/yogurt mixture can then be dried, such as by freeze-drying, to create a honey-yogurt powder 147. In another example: a volume of milk can be added to a vat and heated during a pasteurization process; while the volume of milk is heated, (warm) honey can be added to the volume of milk; and the honey can be mixed into solution with the milk in the vat. In this example, once the pasteurization process is complete, the honey-yogurt solution can be: cooled to a fermentation temperature (e.g., 42° C.); inoculated with yogurt cultures; added to the honey-yogurt solution; held at the fermentation temperature; and then cooled to a completion temperature (e.g., 7° C.) to stop fermentation once the pH of the honey-yogurt solution reaches a target pH (e.g., 4.5). Once the correct pH, consistency, and quality, etc. of the fermented honey-yogurt solution is confirmed, the fermented honey-yogurt solution can be freeze dried to create dried honey-yogurt powder 147.

In this implementation, probiotics in the wet yogurt may persist through the drying process and may be reconstituted when hydrated by liquid added to a cup 110 containing an amount of the dry powder mix 140. Furthermore, by drying wet honey in situ with wet yogurt, additives otherwise necessary to stabilize honey for drying can be excluded from the dry powder mix 140, and less sugar may be added to the dry powder mix 140 to achieve a target sweetness in the completed frozen yogurt serving. In this implementation, similar proportions of honey-yogurt powder 147 can be incorporated into fruity and roasted dry powder mixes, such as ˜6% by mass honey-yogurt powder 147 in both raspberry and chocolate dry powder mixes, as shown in FIG. 6. A honey-flavored dry powder mix 140 can also be created by incorporating a higher proportion of honey-yogurt powder 147 (e.g., ˜25% honey-yogurt powder 147 by mass) and excluding other fruit and roasted flavorings, as shown in FIG. 6.

In another implementation, wet yogurt is prepared, whole granola is crushed and mixed into the wet yogurt (e.g., at a ratio of one part crushed granola to five parts yogurt), and the granola/yogurt mixture is dried (e.g., by freeze-drying) to create a granola-yogurt powder. In this implementation, a granola-flavored dry powder mix 140 can also be created by incorporating a higher proportion of granola-yogurt powder (e.g., ˜18% granola-yogurt powder by mass) and excluding other fruit and roasted flavorings.

Alternatively, plain wet yogurt can be dried into a powder and incorporated into a dry powder mix 140 separately from a sweetener 141.

6.4 Sweetener 141

A dry powder mix 140 also includes a quantity of sweetener 141. In one example, both a raspberry dry powder mix 140 and a chocolate dry powder mix 140 include ˜60% sucrose and ˜6% honey-yogurt powder 147 by mass, as shown in FIG. 6. In this example, a peanut butter dry powder mix 140 can include ˜55% sucrose and ˜10% honey-yogurt powder 147 by mass.

Because sugar increases the rupture stress of junctions formed by the gelling hydrocolloid, the amount of sweetener 141 (e.g., sugar) in a roasted dry powder mix 140 can be less than an amount of such sweetener 141 in fruity dry powder mix 140 in order to match the true rupture stress of a suspension formed from the roasted dry powder mix 140 to a suspension formed from the fruit dry powder mix 140 under substantially similar processing schedules.

6.5 Flavoring

A dry powder mix 140 further includes a quantity of particulate flavoring, such as in powdered or granulated form, as shown in FIG. 6. For example, a raspberry dry powder mix 140 can include ˜18% dried raspberry powder by mass, a blueberry dry powder mix 140 can include ˜18% dried blueberry powder by mass, a chocolate dry powder mix 140 can include ˜21% dried cocoa powder by mass, a peanut butter dry powder mix 140 can include ˜20% ground, dried peanut powder—with fats removed—by mass, and a coffee dry powder mix 140 can include ˜10% ground instant coffee powder by mass. A dry powder mix 140 can also include salt, cinnamon, almond flour, and/or any other suitable powdered or granulated flavoring or flavor-enhancer.

Some fruit-based powdered flavorings can exhibit hydrophilic tendencies and can rehydrate in the presence of moisture relatively rapidly. For example, dried powdered fruit particles, such as raspberry and blueberry flavorings, can exhibit hydrophilic biases and can rehydrate relatively quickly in the presence of a milk product added to a cup 110 and before water in the milk product freezes. However, nut-based powdered flavorings—such as cocoa powder, peanut powder, and instant coffee flavorings—may exhibit hydrophobic tendencies. Because these nut-based powdered flavorings exhibit hydrophobic biases, water in the milk product added to the cup 110 may freeze before these flavorings are fully incorporated into the solution and before the solution is sufficiently homogenous, which may result in weaker flavor, larger free ice crystals, and/or rougher textile in the resulting suspension. To compensate for hydrophobic tendencies of such nut-based flavorings, a serving unit 100 containing a roasted dry powder mix 140 can include more roasted dry powder mix 140 by mass—and therefore a higher ratio of dry powder mix 140 to milk product per serving of frozen yogurt—than a fruity dry powder mix 140.

For example, a first serving unit 100 can include 16.5 grams of fruity dry powder mix 140, including hydrophilic dried raspberry particulate, in a first cup defining a liquid fill level corresponding to a total of 120 grams of milk product—that is, an addition of 103.5 grams of milk product to the first cup to achieve a frozen yogurt serving 120 grams in mass. A second serving unit 100 can include 24 grams of roasted dry powder mix 140, including hydrophobic dried cocoa powder, in a second cup defining a similar liquid fill level corresponding to a total of 120 grams of milk product—that is, an addition of 96 grams of milk product to the second cup to achieve a frozen yogurt serving 120 grams in mass. In this example, the hydrophilic raspberry particulate can relatively rapidly rehydrate and incorporate into the milk product as the beater 130 whips the fruity dry mix powder into the added milk product substantially before water in the added milk product begins to freeze. However, because cocoa powder, a roasted and ground bean, exhibits hydrophobic tendencies, the cocoa powder may rehydrate and incorporate into the milk product more slowly; the greater total amount of cocoa powder in the roasted dry mix powder (given a greater proportion of cocoa powder compared to raspberry particulate and a greater total amount of roasted dry mix powder than fruity dry mix powder) can expose more dry cocoa to less water in the second cup, thereby resulting in a higher ratio of rehydrated cocoa to water, achieving stronger flavor, and reducing frequency of large, free ice crystals in the resulting quantity of frozen yogurt.

In particular, a roasted dry powder mix 140 can include more nut-based, hydrophobic flavoring per target processing of a serving unit 100 than hydrophilic flavoring in a fruity dry powder mix 140 to ensure that at least a minimum proportion of water in liquid added to the serving unit 100 is absorbed into nut-based powder before this water freezes during a processing cycle.

However, fruity and roasted dry powder mixes can include dry powdered flavorings in any other proportion, and serving kits 200 can include any other quantities of fruity and roasted dry powder mixes.

6.6 Large Flavoring Solids

In one variation, the serving unit 100 includes large flavoring solids in addition to a quantity of dry powder mix 140. For example, a cup 110 containing chocolate dry powder mix 140 can also include chocolate cookie crumbs, and a cup 110 containing raspberry dry powder mix 140 can include large dried raspberry flakes.

7. Rehydration of Dry Powder Mix

As described above, in preparation for transforming dry powder mix 140 in a cup 110 into a serving of frozen yogurt (or ice cream, gelato, sorbet, etc.), a user can fill the cup 110 with a liquid, such as cream, whole milk, 2% milk, skim milk, or water, up to the fluid fill level indicator defined by the cup 110. This volume of liquid hydrates components within the dry powder mix 140, such as hydrocolloids and fruit particles. With the cup 110 in a processing apparatus, the beater 130 in the cup 110 mixes the powder into the liquid to break clumps of powder and to achieve substantially uniform distribution of powder in the volume of liquid as the cup 110 is cooled. However, the liquid and dry powder mix 140 may thicken and gel according to different pathways and/or to different degrees based on a type of the liquid.

In a first example, whole milk is added to a cup 110 containing fruity dry powder mix. In this first example, acids in the fruity dry powder mix 140 cause proteins in the milk and in the yogurt to coagulate, thereby gelling the resulting suspension, as described above. Furthermore, fat in the whole milk and yogurt mixes with the thickening hydrocolloid in the fruity dry powder mix 140 to improve distribution of these hydrocolloids in the suspension. Components in the volume of whole milk added to the cup 110 can therefore cooperate with components in the fruity dry powder mix 140 to thicken and gel the suspension as the suspension is beaten and cools in the processing apparatus. (Similarly, for whole milk added to a cup 110 containing roasted dry powder mix 140, fat in the whole milk can improve dispersion of thickening and gelling hydrocolloids in the suspension, and calcium and sugar in the dry powder mix 140 can increase the rupture stress of junctions formed by the gelling hydrocolloid.)

In a second example, skim milk is added to a cup 110 containing fruity dry powder mix. This volume of skim milk contains more calcium, more protein, and less fat than the same volume of whole milk described in the first example above. In order to compensate for less hydrocolloid dispersion due to reduced fat in skim milk, the dry powder mix 140 can contain sufficient acid to coagulate the additional protein in the skim milk in order to achieve gelling and thickening of the skim milk suspension that approaches gelling and thickening of the whole milk suspension described above. (Similarly, for skim milk added to a cup 110 containing roasted dry powder mix 140, the additional calcium in the skim milk can further increase the rupture stress of junctions formed by the gelling hydrocolloid in order to compensate for less hydrocolloid dispersion due to reduced fat in skim milk and to achieve gelling of the skim milk suspension that approaches gelling and thickening of the whole milk suspension for roasted dry powder mix 140 as described above.)

In a third example, water is added to a cup 110 containing fruity dry powder mix. In this third example, lack of milk protein in the added liquid can result in significantly less gelling of the suspension compared to the first and second examples above. However, the higher water content in the cup 110 in this third example can yield a greater proportion of ice crystals in the suspension, and the suspension can thus achieve a sufficiently hard, rigid structure upon completion of a processing cycle despite such minimal gelling from milk proteins in the yogurt alone. (Similarly, for water added to a cup 110 containing roasted dry powder mix 140, thickening hydrocolloids in the roasted dry powder mix 140 thicken the suspension and gelling hydrocolloids in the roasted dry powder mix 140 gel the suspension, as described above, cooperate to achieve rigidity and texture of suspension similar to a roasted dry powder mix 140 combined with a milk product.)

Therefore, both fruity and roasted dry powder mixes can include combinations of hydrocolloids, sweetener 141, powdered yogurt 147, acid, and/or powdered flavoring that cooperate to thicken and gel during substantially similar processing schedules (e.g., cooling times, temperature thresholds, viscosities, and beater speed parameters) despite a type of liquid added to cups containing these dry powder mixes.

As a person skilled in the art will recognize from the previous detailed description and from the figures and claims, modifications and changes can be made to the embodiments of the invention without departing from the scope of this invention as defined in the following claims.

I claim:

1. A serving unit comprising:
a base;
a wall extending from the base, comprising a frustoconical section, and defining a central axis;
a rim extending from an upper edge of the wall;
a seal extending across the rim and transiently enclosing a cavity defined by the wall and the base;
a beater arranged within the cavity, configured to rotate about the central axis, and comprising:
a first blade configured to extend along the base and up a portion of the wall;
a second blade radially offset from the first blade and configured to extend along the base and up a portion of the wall; and
a drive coupling interposed between the first blade and the second blade and extending opposite the base; and
a dry powdered food product arranged within the cavity and comprising:
a first quantity of flavoring;
a second quantity of sweetener; and
a third quantity of thickener.

2. The serving unit of claim 1:
wherein the base, the wall, and the rim comprise a unitary metal structure configured to engage a cooled receptacle within a frozen food processing apparatus and to communicate thermal energy from the dry powdered food product and an amount of liquid, added to the cavity, to the receptacle; and
further comprising a polymeric coating applied across interior surfaces of the base, the wall, and the rim.

3. The serving kit of claim 2, wherein the rim defines a tab configured to engage a feature extending from the frozen food processing apparatus adjacent the cooled receptacle and to prevent rotation of the unitary metal structure within the cooled receptacle during rotation of the beater.

4. The serving unit of claim 1, wherein the base defines a stanchion extending toward the rim and configured to locate the drive coupling in coaxial alignment with the central axis.

5. The serving unit of claim 4:
wherein the wall further comprises a visual indicator of a fluid fill level for the cavity;
wherein the stanchion extends toward the rim and defines a bearing surface between the visual indicator and the rim;
wherein the drive coupling is configured to mate with the bearing surface;
wherein the first blade is configured to extend down the stanchion, along the base, and up a portion of the wall; and
wherein the second blade is configured to extend down the stanchion, along the base, and up a portion of the wall.

6. The serving unit of claim 1:
wherein the first blade comprises a wiper section configured to extend up a portion of the wall and to wipe rehydrated volumes of the dry powdered food product onto the wall; and
wherein the second blade comprises a scraper section configured to extend up a portion of the wall and to scrape frozen layers of rehydrated volumes of the dry powdered food product off of the wall.

7. The serving unit of claim 1:
wherein the first quantity of flavoring comprises:
a quantity of dried fruit particles; and
a quantity of citric acid matched to the quantity of dried fruit particles;
wherein the second quantity of sweetener comprises a powdered blend of honey and yogurt dried conjointly;
wherein the third quantity of thickener comprises:
a quantity of a second acid distinct from citric acid and configured to cooperate with the quantity of citric acid to gel proteins in a volume of milk product added to the cavity; and
a quantity of hydrocolloid in a disperse phase, configured to rehydrate in the presence of the volume of milk product added to the cavity, and configured to form a network of polymer chains within the volume of milk product.

8. The serving unit of claim 1:
wherein the first quantity of flavoring comprises dried nut powder;
wherein the second quantity of sweetener comprises sugar granules; and
wherein the third quantity of thickener comprises:
a quantity of a lactic acid configured to gel proteins in a volume of milk product added to the cavity; and
a quantity of hydrocolloid configured to rehydrate in the presence of the volume of milk product added to the cavity and to form a network of polymer chains within the volume of milk product.

9. A serving kit comprising:
a first cup defining a first cavity and configured to engage a cooled receptacle within a frozen food processing apparatus;
a first beater configured to rotate within the cavity and comprising a drive coupling configured to engage a motorized shaft extending from the frozen food processing apparatus over the cooled receptacle;
a first amount of dry powdered food product arranged within the first cavity; and
a first seal transiently arranged over the first cavity and transiently sealing the first dry powdered food product within the first cavity.

10. The serving kit of claim 9, wherein the first amount of dry powdered food product comprises:
a first proportion of dried fruit particles;
a first proportion of citric acid matched to the quantity of dried fruit particles and configured to gel proteins in a volume of milk product added to the first cup;
a first proportion of thickening hydrocolloid in a disperse phase, configured to rehydrate in the presence of the volume of milk product added to the first cup, and configured to form a network of polymer chains within the volume of milk product;
a first proportion of powdered yogurt; and
a first proportion of dry sweetener.

11. The serving kit of claim 10: wherein the first amount of dry powdered food product further comprises a first proportion of a second acid distinct from citric acid and configured to cooperate with the first proportion of citric acid to gel proteins in a volume of milk product comprising one of whole milk, 2% milk, skim milk, soy milk, and almond milk manually added to the first cavity following removal of the first seal from the first cup.

12. The serving kit of claim 10, wherein the first proportion of dry sweetener comprises:
a first mass of sugar; and
a second mass of powdered honey and yogurt dried conjointly.

13. The serving kit of claim 10, further comprising:
a second cup defining a second cavity, configured to engage the cooled receptacle within the frozen food processing apparatus, and packaged with the first cup;
a second beater configured to rotate within the second cavity;
a second amount of dry powdered food product arranged within the second cavity and comprising:
a second proportion of dried ground nut particulate greater than the first proportion of dried fruit particles;
a second proportion of thickening hydrocolloid in the disperse phase and greater than the first proportion of thickening hydrocolloid;
a second proportion of powdered yogurt approximating the first proportion of powdered yogurt; and
a second proportion of sweetener approximating the first proportion of sweetener; and
a seal transiently arranged over the second cavity and transiently sealing the second dry powdered food product within the second cavity.

14. The serving kit of claim 13:
wherein the first proportion of dried fruit particles comprises dried raspberry particles exhibiting hydrophilic bias; and
wherein the second proportion of dried ground nut particulate comprises cocoa powder exhibiting hydrophobic bias.

15. The serving kit of claim 13:
wherein the first cup indicates a first fluid fill level representing a first volume within the first cavity;
wherein the second cup indicates a second fluid fill level representing a second volume within the second cavity, the second volume equivalent to the first volume;
wherein the second amount of dry powdered food product exceeds the first amount of dry powdered food product.

16. The serving kit of claim 9:
wherein the first cup comprises:
a base;
a wall extending from the base, comprising a frustoconical section, defining a central axis, and cooperating with the base to define the first cavity; and
a rim extending from an upper edge of the wall;
wherein the seal extends across the rim to transiently enclose the first cavity; and
wherein the beater is configured to rotate about the central axis and comprises:
a first blade configured to extend along the base and up a portion of the wall;
a second blade radially offset from the first blade and configured to extend along the base and up a portion of the wall; and
the drive coupling interposed between the first blade and the second blade and extending opposite the base.

17. A serving kit comprising:
a first container;
a first amount of fruity dry powdered food product sealed within the first container and comprising:
a first proportion of dried fruit particles;
a first proportion of citric acid matched to the quantity of dried fruit particles and configured to gel proteins in a first volume of milk product added to the first container;
a first proportion of thickening hydrocolloid in a disperse phase, configured to rehydrate in the presence of the first volume of milk product added to the first container, and configured to form a network of polymer chains within the volume of milk product;
a first proportion of powdered yogurt; and
a first proportion of dry sweetener;
a second container; and
a second amount of nutty dry powdered food product sealed within the second container and comprising:
a second proportion of dried ground nut particulate greater than the first proportion of dried fruit particles;
a second proportion of thickening hydrocolloid greater than the first proportion of thickening hydrocolloid, the second proportion of thickening hydrocolloid in the disperse phase, configured to rehydrate in the presence of a second volume of milk product added to the second container, and configured to form a network of polymer chains;
a second proportion of powdered yogurt approximating the first proportion of powdered yogurt; and
a second proportion of sweetener approximating the first proportion of sweetener.

18. The serving kit of claim 17:
wherein the first container defines a first cup configured to engage a cooled receptacle within a frozen food processing apparatus and comprises:
a first base;
a first wall extending from the first base, comprising a first frustoconical section, and defining a first central axis;
a first beater arranged within the first cavity, configured to rotate about the first central axis, and comprising:
a first blade configured to extend along the first base and up a portion of the first wall;
a second blade radially offset from the first blade and configured to extend along the first base and up a portion of the first wall; and
a first drive coupling interposed between the first blade and the second blade, extending opposite the first base, and configured to engage a motorized shaft extending from the frozen food processing apparatus over the cooled receptacle; and
a first seal transiently sealing the first beater and the fruity dry powdered food product within a first cavity defined by the first wall and the first base;
wherein the second container defines a second cup configured to engage the cooled receptacle within the frozen food processing apparatus and comprises:
a second base;
a second wall extending from the second base, comprising a second frustoconical section, and defining a second central axis;
a second beater arranged within the second cavity and configured to rotate about the second central axis; and
a second seal transiently sealing the second beater and the nutty dry powdered food product within a second cavity defined by the second wall and the second base.

19. The serving kit of claim 18:
wherein the first container indicates a first fluid fill level representing a first volume within the first cavity;
wherein the second container indicates a second fluid fill level representing a second volume within the second cavity, the second volume equivalent to the first volume;
wherein the second amount of nutty dry powdered mix exceeds the first amount of fruity dry powdered mix.

20. The serving kit of claim 17:
wherein the first proportion of dried fruit particles comprises dried raspberry particles;
wherein the first amount of fruity dry powdered food product further comprises a first proportion of a lactic acid configured to cooperate with the first proportion of citric acid to gel proteins in the first volume of milk product added to the first cup;
wherein the second proportion of dried ground nut particulate comprises cocoa powder; and
wherein the second proportion of thickening hydrocolloid comprises a blend of locust bean gum and guar gum.
